(19) United States
(12) Patent Application Publication
(10) Pub. No.: US 2010/0077124 A1
(43) Pub. Date: Mar. 25, 2010

(54) METHOD AND CONTROL UNIT FOR ELECTRONIC CONTROL AND FEEDBACK CONTROL

(76) Inventor: Heinz Siegel, Bremen (DE)

Correspondence Address: SCHMEISER, OLSEN & WATTS, 22 CENTURY HILL DRIVE, SUITE 302, LATHAM, NY, 12110, US

(21) Appl. No.: 12/563,450

(22) Filed: Sep. 21, 2009

(30) Foreign Application Priority Data
Sep. 23, 2008 (DE) 102008048619.1

(51) Int. Cl. G06F 13/20

(52) U.S. Cl. 710/305

(57) ABSTRACT

The present invention relates to a method for electronic control and/or feedback control. In this system, the sequence for execution of a statement within a control unit is simplified, the flexibility and adaptability of the control unit are enhanced and the potential achievement of an enhanced computing speed is increased, by means of the provision that in this method a plurality of input registers (17, 41) is assigned to a plurality of output registers (25, 49), a specific respective reference value is deposited in the input registers (17, 41) and a specific respective response is deposited in the output registers (25, 49), wherein a statement is applied to the input registers (17, 41) and, based on congruence of at least one sub-element of the statement with the reference value of an input register (17, 41), the response of the output register (25, 49) assigned to the input register (17, 41) is triggered.

This application is based on German patent application number 10 2008 048 619.1

### BACKGROUND OF INVENTION

1. Technical Field

The present invention relates to a method and a control unit for electronic control and/or feedback control

2. Related Art

Such methods and control units are known as components of a processor from computer technology.

In such an environment, the control unit serves for control of a computer program sequence and/or the conversion of statements into control pulses, for instance on the basis of a program. In interaction with registers and the arithmetic-logic unit, the control unit constitutes the processor and acts as a main component of the processor. The control unit coordinates, for example, the interaction with the arithmetic-logic unit and an operating memory. Moreover, the system is capable of interacting with the input and output control unit, thus coordinating the data exchange by means of input and output devices. It is the task of the control unit to control the processing of a program. In such a cycle, one command after the other is executed by the control unit of a micro processor, for instance.

Conventional control units comprise usually a command register, a command decoder and an instruction counter. The statements of a program are usually composed of an operation part and an address part, with the operation part specifying the operation to be carried out whereas the address part contains the address of the memory cell whose contents are envisaged for use in execution of the operation. It is therefore necessary for the execution of a statement that the statement is initially demanded and/or addressed. Subsequently, the statement must be decoded whereupon those operands are loaded on which the statement is to be applied. In a last step, eventually the instruction counter is updated. It is only by that point of time that a new statement can be processed. In this setting, there is the disadvantage that the sequence of addressing, decoding, reading, the execution proper of the operation and updating the instruction counter is carried out for each statement and is highly time-consuming on account of the great number of necessary processing steps for a single statement. The further disadvantage is involved that the control unit as such is not programmable. This fact restricts the flexibility and the great variety of applications.

The aforementioned sequence for execution of a statement with use of the control unit can be implemented by means of a direct control system, a so-called “hard-wired system”. In micro processors, for instance, a hard-wired control system is employed for execution of frequently used statements or instructions or sub-elements of an instruction. The hard-wired control system involves the disadvantage of a resulting complex structure which is thus difficult to reproduce. As a consequence, there is the risk that errors may occur, on the one hand, when the hard-wire control system is set up and that error sources are difficult to identify, on the other hand. Furthermore, the low flexibility is another disadvantage with variations that may become necessary.

Processors are moreover known to include so-called micro function control units, for instance in combination with a hard-wired controller, for execution of complex or less time-critical statements, for example. In a micro program control unit, a sequence control function is performed on the basis of a micro program stored in a memory. In such settings, micro program control units constitute some kind of a stored-program control system (SPC).

A stored-program controller (SPC) serves equally for control and/or feedback control of a machine or installation. In such a configuration, certain predetermined modules are available which are virtually combined, for instance via a graphic user interface, in the manner of a modular system. An SPC system is based, as a rule, on a micro controller provided with its own processor. In such a case, the processor comprises, in its turn, a control unit of the common type. Hence, on the one hand, an SPC unit is not freely programmable on account of the modules predetermined in the rule. On the other hand, the SPC system is based on a non-programmable control unit. As a result, time-consuming and complex sequences as well as the disadvantage of a restricted flexibility and adaptability arise for the execution of a statement on account of the predetermined modules and/or the non-programmable control unit.

The mode of operation of the control units so far known, which include an invariably predetermined sequence scheme to be processed serially, requires the parallel connection of a plurality of processors in order to increase the computing power or the computing rate. This configuration involves the risk of incorrect processing of the sequence scheme which may result, for instance, on account of the latter's complexity.

The problem underlying the present invention consists in providing a method and a control unit in such a form that the sequence for execution of a statement within the control unit will be simplified, that the flexibility and the adaptability of the control unit will be enhanced and that the computing rate will be increased.

### SUMMARY OF INVENTION

For a solution to this problem, the invention provides a method of electronic control and/or feedback control by means of a control unit, wherein a plurality of input registers is assigned to a plurality of output registers, with an input register being connected to the assigned output register by means of a through-connecting line, wherein a specific respective reference value is deposited in said input registers whilst a specific respective response is deposited in said output registers, wherein a statement is applied to said input registers and wherein, based on congruence of at least one sub-element of said statement with said reference value of an input register, the response of the output register assigned to said input register is triggered.

Furthermore, the invention provides a solution to the problem underlying the invention by proposing a control unit for electronic control and/or feedback control, comprising a plurality of input registers and a plurality of output registers, wherein an input register is connected to the assigned output register by means of a through-connecting line, wherein a specific reference value is deposited in each input register and a specific response is deposited in each output register, wherein an input register is assigned to an output register, and wherein, when a statement is applied to said input registers, the response of the output register assigned to the input register can be triggered on account of congruence of at least one sub-element of said statement with said reference value of an input register.

The present invention hence provides an entirely new and independent type of a control unit. The sequence for execution of a statement is substantially simplified by this unit. The control unit as such need not become active in order to demand and/or address the statement initially. The statement rather addresses itself instead, based on its contents. The input registers contain a respective reference value, with any conceivable and/or sensible statements being considered by means of the input registers and the reference values deposited there. In such a configuration, the statements may be assigned by a signal generator, such as a working or main memory and/or a sensor, to the input registers. When a statement to be executed is now pending at the input registers the statement is automatically compared against the reference values. If the statement is congruent with a reference value of an input register the input register activates the associated output registers. This function triggers and executes the response deposited in the output registers.

On account of the connection of the input register with the associated output register by means of a through-connecting line, the output register is directly activated, without any loss in terms of time, as a function of the result of the comparison of the statement against the reference value. The response deposited in the output register is accordingly triggered due to the through-connection.

In such a system, the response may be assigned to a signal-exploiting unit such as an arithmetic-logic unit and/or an actor. One can hence unambiguously determine which statement will trigger a specific response. This facilitates the determination of a program sequence and the finding of potential sources of error. It is furthermore possible that merely one sub-element of the statement must be congruent with the reference value of an input register in order to trigger the appertaining response. With such a concept, it is sufficient that the sub-element of a statement having a data width wider than that of a reference value is in congruence with this reference value. The sub-element may be a first constituent of the statement, in particular. The further constituent of the statement is ignored by the input registers having a reference value of a data width shorter than that of the statement. Moreover, it is expedient that the reference value of an input register and/or the response of an output register may be freely determined. The inventive control unit is hence anything but a mere “sequential logic system” but rather enables a direct and freely determinable configuration. Apart there from, the inventive method or control unit, respectively, permits the simultaneous and parallel processing of a plurality of statements. This feature results in a further increase of the computing speed.

In correspondence with another embodiment of the inventive method, the reference value and/or the response are deposited by way of free programming. The control unit as such is hence freely programmable, too. This permits the implementation of a high flexibility and adaptability of the control unit with a view to the desired specific application.

In correspondence with an improved embodiment, the reference value and/or the response are deposited with n bits, with n being any natural number (positive integer) whatsoever and with n being preferably determined by the register capacity of the input register and/or the output register. Depending on the specific application, the control unit may be provided with input registers and/or output registers, each of different register capacity. The number of the input registers and/or output registers may be open to free selection, in particular as a function of the specific application.

In accordance with another embodiment of the inventive control unit, the reference value and/or the response may be freely determined, in particular freely programmed. Hence a high flexibility and adaptability of the control unit—for instance with a view to the envisaged specific application—can be implemented. The reference value and/or the response can preferably be deposited with n bits, with n being any natural number (positive integer) whatsoever and with n being preferably determined by the register capacity of the input register and/or the output register.

Moreover, the statement may have a width of m bits, with m being any natural number (positive integer) whatsoever. The width of the statement of m bits may be different from the width of the reference value and/or the response including n bits; in particular, the width of the reference value having n bits may be smaller than the width of the statement having m bits. Furthermore, the response may have a width of k bits, with k being any natural number (positive integer) whatsoever. The statement, the reference value and/or the response may each have hence a respective different bit width.

In accordance with an improved embodiment, one or more input lines are assigned to the input registers. Thus, one or more statements may be compared against reference values in one or several input registers, in particular simultaneously and/or in parallel. Thus, one and/or several statements, in particular statements independent of each other, may induce different responses. This concept permits the implementation of a higher computing power or rate, respectively.

One or more output lines are preferably assigned to the output registers. With this concept it is possible to trigger responses independent of each other as a function of the statements and/or the input registers, particularly at the same time and/or in parallel. This feature results in a further enhancement of the computing power or rate, respectively.

In correspondence with another embodiment, a plurality of input registers is assigned to a single output register. In this manner, different statements may result in the execution of the same response. It is also possible, however, to assign precisely one input register to a plurality of output registers. As a result, based on one statement, several statements, in particular statements different from each other, are preferably executed simultaneously and/or in parallel. It is preferred that precisely one output register is assigned to precisely one input register. As a result, precisely one response is triggered on the basis of a particular statement.

In accordance with one embodiment, at least one of the output registers is connected to one of the input registers by means of a feedback line. The output lines and input lines connected by the feedback line are not connected to external inputs or output, respectively. The feedback line rather furnishes the opportunity to establish a direct or immediate feedback between or among one or several output registers and one or several input registers. Moreover, this concept results in even more freedom of design and layout with a view to the implementation of an inventive control unit.

The application of the inventive method and/or of the inventive control unit is of particular advantage for the implementation of a micro controller and/or micro processor, a stored-program controller (SPC) and/or a data processing system. In such applications, the micro controller, the micro processor and/or the stored-program controller are based, however, on a freely programmable control unit.

### BRIEF DESCRIPTION OF THE DRAWINGS

The invention will now be explained in more details in the following with reference to embodiments and to the attached drawings wherein:

FIG. 1 is a schematic illustration of a first inventive control unit;

FIG. 2 is a schematic illustration of a second inventive control unit;

FIG. 3 is a schematic illustration of a third inventive control unit;

FIG. 4 is a schematic illustration of a further inventive control unit;

### DETAILED DESCRIPTION OF THE INVENTION

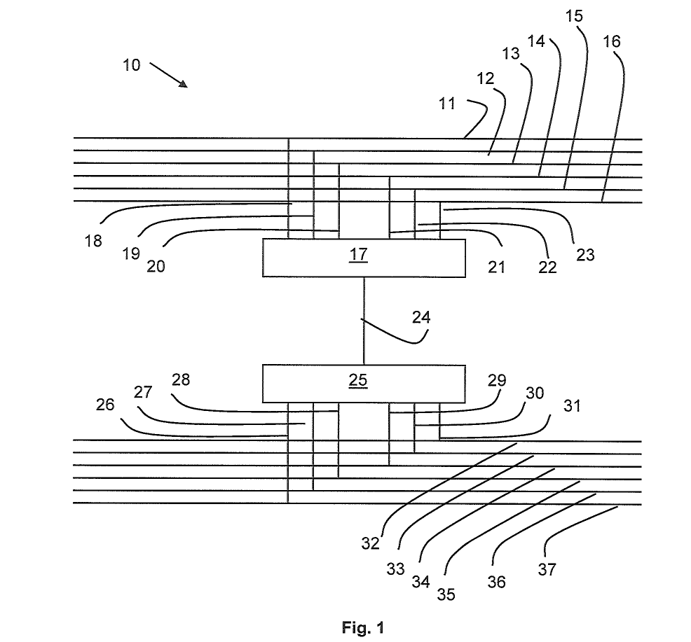

FIG. 1 is a schematic illustration of a control unit 10. The control unit 10 comprises input lines 11, 12, 13, 14, 15, 16. These input lines 11 . . . 16 are connected to a signal generator in a manner not shown in further details, which is configured here as working memory. Moreover, the control unit 10 comprises an input register 17 that is connected by lines 18, 19, 20, 21, 22, 23 to the input lines 11 . . . 16, specifically line 18 to the input line 11, line 19 to the input line 12, line 20 to the input line 13, line 21 to the input line 14, line 22 to the input line 15, and line 23 to the input line 16.

The input register 17 is connected to an output register 25 by means of a through-connecting line 24. The output register 25 in its turn is connected by means of lines 26, 27, 28, 29, 30, 31 to output lines 32, 33, 34, 35, 36, 37. In this configuration, too, precisely one line 26 . . . 31 is connected to precisely one output line 32 . . . 37, specifically line 26 to the output line 37, line 27 to the output line 36, line 28 to the output line 35, line 29 to the output line 34, line 30 to the output line 33 and line 31 to the output line 32.

The output lines 32 . . . 37 are connected to a signal-exploiting unit in a manner not shown in more details, with this unit being configured as arithmetic-logic unit.

The input register has a width of n bits, with n being six in this case. A reference value is deposited in the input register 17, which is deposited in a 6-bit binary representation in correspondence with the bit width of the input register 17. Moreover, the output register has a width of equally 6 bits. A corresponding response is deposited in the output register, which is deposited in the output register 25 in a 6-bit binary representation.

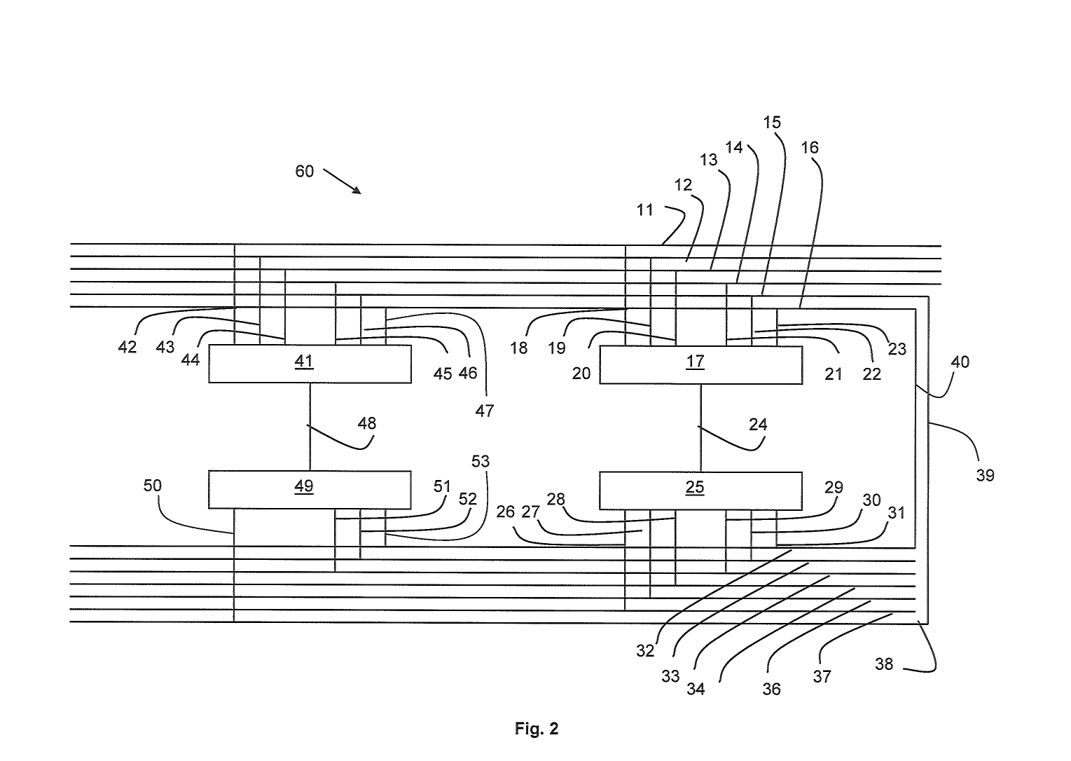

FIG. 2 shows a control unit 60. In correspondence with FIG. 1, this control unit 60 comprises input lines 11 . . . 16, an input register 17, lines 18 . . . 23, a through-connecting line 24, an output register 25, lines 26 . . . 31 and output lines 32 . . . 37.

The control unit 60 comprises moreover another output line 38 which is connected by means of a feedback line 39 to the input line 15. Furthermore, the output line 32 is connected by means of a feedback line 40 to the input line 16. The function of the feedback lines 39, 40 will be explained in more details in the following. Each of the input lines 15, 16 and the output lines 32 and 38 is not connected to the working memory or the arithmetic-logic unit, respectively. Merely the input lines 11, 12, 13, 14 and the output lines 33, 34, 35, 36, 37 are connected to the working memory or the arithmetic-logic unit, respectively, in a manner not illustrated here in more details.

A further input register 41 is connected by means of lines 42, 43, 44, 45, 46, 47 to the input lines 11 . . . 16, in addition to the input register 17. In this configuration, precisely one of the lines 42 . . . 47 is connected to precisely one input line 11 . . . 16, specifically line 42 to the input line 11, line 43 to the input line 12, line 44 to the input line 13, line 45 to the input line 14, line 46 to the input line 15 and line 47 to the input line 16.

The input register 41 is connected to another output register 49 by means of a through-connecting line 48. The lines 50, 51, 52, 53 connect the output register 49 to the output lines 32, 33, 34, 38. In this configuration, line 60 is connected to the output line 38, line 51 to the output line 34, line 52 to the output line 33 and line 53 to the output line 32.

A reference value is deposited in a 6-bit representation in the input register 41, which reference value is different from the reference value in the input register 17. A response, defined in a 6-bit representation, is deposited in the output register 49.

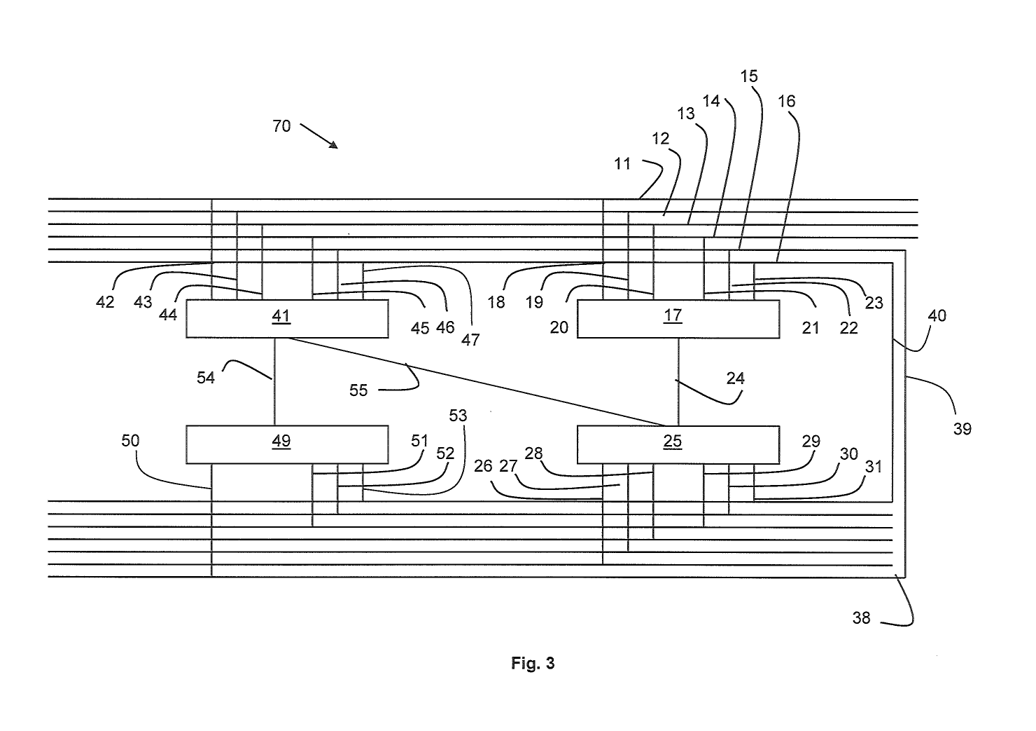

FIG. 3 shows a schematic illustration of a third control unit which corresponds essentially to the structure of the control unit 60 according to FIG. 2. The control unit 70 comprises, however, a first through-connecting line 54 instead of the through-connecting line 48 as well as an additional second through-connecting line 55.

The through-connecting line 54 serves to connect the input register 41 to the output register 49 whereas the through-connecting line 55 serves to connect the input register 41 to the output register 25.

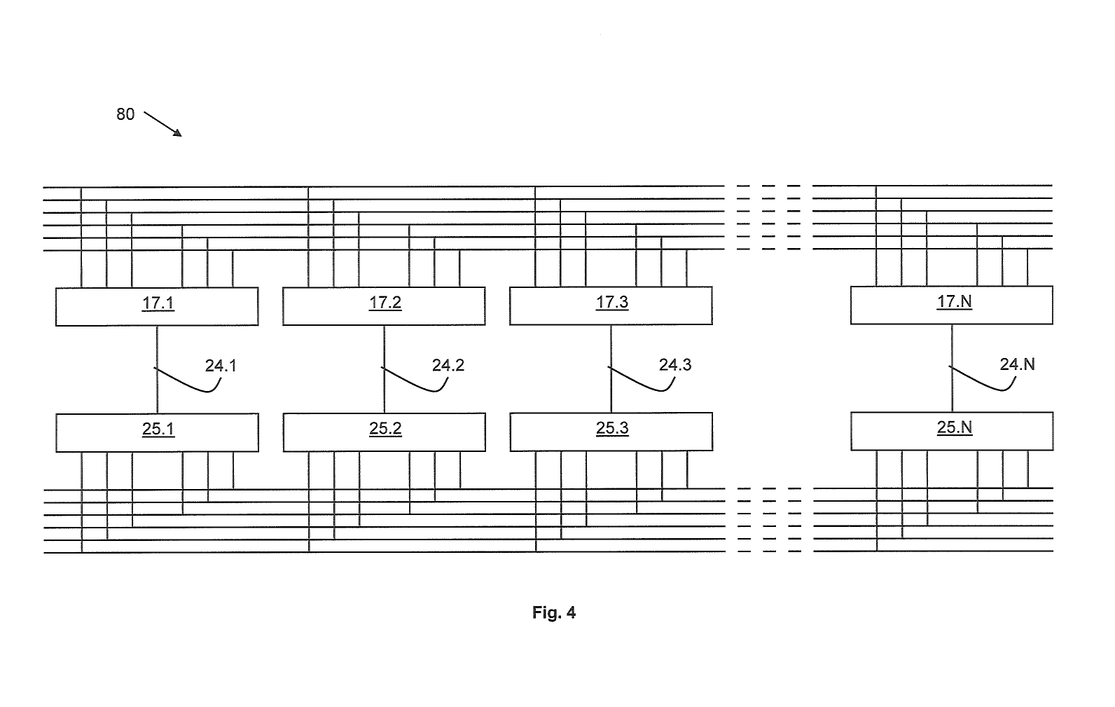

FIG. 4 is a schematic illustration of another control unit 80. The control unit 80 comprises a plurality of input registers 17.1, 17.2, 17.3 to 17.N, through-connecting lines 24.1, 24.2, 24.3 to 24.N and output registers 25.1, 25.2, 25.3 to 25.N, which correspond essentially to the input register 17, the through-connecting line 24 and the output register 25 according to FIG. 1. In this configuration, N is any natural number (positive integer) that defines the total number of the input registers and output registers connected in successive series. A designation of the input lines, output lines as well as the further lines in analogy to the lines according to FIG. 1 is omitted here to the benefit of a clearer overall view.

The input registers 17.1, 17.2, 17.3 to 17.N contain the same respective reference values and/or reference values different from each other whilst the same respective responses or responses different from each other are deposited in the output registers 25.1, 25.2, 25.3 to 25.N. In such a configuration, precisely one output register 25.1, 25.2, 25.3 to 25.N is assigned to each of the input registers 17.1, 17.2, 17.3 to 17.N.

The following is a more detailed description of the mode of operation of the inventive control unit, presented with reference to FIGS. 1 to 4.

As soon as a statement is pending at one or several of the input lines 11 . . . 16, e.g. in accordance with FIG. 1, this statement is passed on by means of the input lines 11 . . . 16 and the lines 18 . . . 23 to the input register 17. Then the statement is compared against the reference value deposited in the input register directly, without any loss in terms of time. When the statement is congruent with the reference value the input register 17 connects through and an activation signal arrives from the input register 17 at the output register 25 by means of the through-connecting line 24. The response deposited in the output register 25 is then immediately supplied by means of the lines 28 . . . 31 to the output lines 32 . . . 37 and hence to an arithmetic-logic unit assigned to the output lines 32 . . . 37. The desired operation is executed by means of this arithmetic-logic unit. Then a statement is supplied to the input register 17 directly—or, in accordance with an alternative, several statements are supplied to the input register 17 directly in parallel along several ones of the input lines 11 . . . 16—and compared against the deposited reference value in order to activate the output register 25 to trigger the response as a function of the result of the comparison. It is hence not necessary to make provisions for the statement to be demanded and/or addressed from the control unit. As a consequence, the number of the required steps of operation or the expenditure for the sequence up to execution of a specific statement is distinctly reduced. Apart there from, a directly programmable control unit is achieved on account of the freely determinable reference value and the freely determinable response.

Such a setting involves the particular advantage that one can dispense with the use of machine codes when the reference value and/or the response is or are programmed. It is possible, for instance, to program thus the reference value and/or the response by means of an appropriate assembler language. This results in better readability for the user and/or the programmer.

The foregoing description in relation to the mode of operation of the input register 17 and the output register 25 is to be transferred by way of analogy to the input register 41 and the output register 49 in accordance with FIGS. 2, 3 and 4.

In the control unit 60 according to FIG. 2, merely the input lines 11, 12, 13 and 14 are assigned to a working memory not shown in more details here. The input lines 15, 16, by contrast, are directly connected by means of feedback lines 39, 40 to the output lines 32 or 38, respectively. Hence, the output registers 25, 49 are directly connected to the input registers 17, 41. The feedback scheme that can be implemented in this manner enables direct or indirect influence on the statement. If necessary or applicable, thus one or several new responses may be triggered as a function of the response.

In accordance with the embodiment shown in FIG. 4 it is possible to use an optional, however defined, number of input registers and/or output registers in sequential series, with precisely one output register being assigned to each input register. Due to the different assignment of input lines and/or output lines the implementation of a parallel function becomes possible, which is impossible, for instance, with conventional micro processors. This parallel function may be achieved for the reason that the result of a comparison between a statement and a first input register in correspondence with the selected assignment of input lines and output lines may not take any influence on the comparisons of the latter and/or another statement against one or several other input registers. Moreover, a parallel function may be achieved in which a first group of input lines and hence a first group of statements is assigned, for example, to a first group of input registers whilst another group of input lines or statements is assigned to another group of input registers. In this manner, it is possible to process different statements in parallel and simultaneously by means of the inventive method and/or the inventive control unit.

List of Reference Numerals:

| | |
|---|---|
| 10 | control unit |
| 11 | input line |
| 12 | input line |
| 13 | input line |
| 14 | input line |
| 15 | input line |
| 16 | input line |
| 17 | input register |
| 18 | line |
| 19 | line |
| 20 | line |
| 21 | line |
| 22 | line |
| 23 | line |
| 24 | through-connecting line |
| 25 | output register |
| 26 | line |
| 27 | line |
| 28 | line |
| 29 | line |
| 30 | line |
| 31 | line |
| 32 | output line |
| 33 | output line |
| 34 | output line |
| 35 | output line |
| 36 | output line |
| 37 | output line |
| 38 | output line |
| 39 | feedback line |
| 40 | feedback line |
| 41 | input register |
| 42 | line |
| 43 | line |
| 44 | line |
| 45 | line |
| 46 | line |
| 47 | line |
| 48 | through-connecting line |
| 49 | output register |
| 50 | line |
| 51 | line |
| 52 | line |
| 53 | line |
| 54 | through-connecting line |
| 55 | through-connecting line |
| 60 | control unit |
| 70 | control unit |
| 80 | control unit |

1. A method of electronic control and feedback control by means of a control unit (10, 60, 70), wherein
a plurality of input registers (17, 41) is assigned to a plurality of output registers (25, 49);
at least one of said input registers (17, 41) being assigned to at least one of said output registers (25, 49) by means of a through-connecting line (24, 54, 55);
a specific reference value is deposited in said input registers (17, 41) whilst a specific response is deposited in said output registers (25, 49);
a statement is applied to said input registers (17, 41); and
said response of at least one of said output registers (25, 49) assigned to said at least one input registers (17, 41) is triggered based on congruence of at least one sub-element of said statement with said reference value of at least one of said input registers (17, 41).

2. The method of claim 1, wherein said reference value and said response is deposited by way of free programming.

3. The method of claim 1, wherein said reference value and said response are deposited with n bits, with n being any natural number (positive integer) and n being preferably determined by the register capacity of said input register (17, 41) and said output register (25, 49).

4. A control unit for electronic control and feedback control, comprising a plurality of input registers (17, 41) and a plurality of output registers (25, 49), wherein
at least one input register (17, 41) is assigned to at least one of said output register (25, 49) by means of a through-connecting line (24, 54, 55);
a specific reference value is deposited in each input register (17, 41);
a specific response is deposited in each output register (25, 49);
when a statement is applied to said input registers (17, 41), the response of at least one of said output registers (25, 49) can be triggered on account of congruence of at least one sub-element of said statement with said reference value of at least one of said input registers (17, 41).

5. The control unit of claim 4, wherein said reference value is freely determinable, particularly freely programmable.

6. The control unit of claim 4, wherein said response is freely determinable, particularly freely programmable.

7. The control unit of claim 4, wherein said reference value and said response can be deposited with n bits, with n being any natural number (positive integer) and with n being preferably determined by the register capacity of said input register (17, 41) and output register (25, 49).

8. The control unit of claims 4, wherein said statement has a width of m bits, with m being any natural number.

9. The control unit of claim 4, wherein one or more input lines (11, 12, 13, 14, 15, 16) are assigned to said input registers (17, 41).

10. The control unit of claim 4, wherein one or more output lines (32, 33, 34, 35, 36, 37, 38) are assigned to said output registers (25, 49).

11. The control unit of claim 4, wherein one or more input lines (11, 12, 13, 14, 15, 16) are assigned to said input registers (17, 41) and one or more output lines (32, 33, 34, 35, 36, 37, 38) are assigned to said output registers (25, 49).

12. The control unit of claim 4, wherein a plurality of input registers (17, 41) is assigned to precisely one output register (25, 49).

13. The control unit of claim 4, wherein precisely one input register (17, 41) is assigned to a plurality of output registers (25, 49).

14. The control unit of claim 4, wherein precisely one output register (25, 49) is assigned to precisely one input register (17, 41).

15. The control unit of claim 4, wherein at least one of said output registers (25, 49) is connected to at least one input register (17, 41) by means of a feedback line (39, 40).

16. A micro controller and a micro processor, stored-program controller (SPC) and a data processing system comprising a control unit having a plurality of input registers (17, 41) and a plurality of output registers (25, 49), wherein
at least one input register (17, 41) is assigned to at least one of said output register (25, 49) by means of a through-connecting line (24, 54, 55);
a specific reference value is deposited in each input register (17, 41);
a specific response is deposited in each output register (25, 49);
when a statement is applied to said input registers (17, 41), the response of at least one of said output registers (25, 49) can be triggered on account of congruence of at least one sub-element of said statement with said reference value of at least one of said input registers (17, 41).

17. The micro controller and micro processor, stored-program controller (SPC) and data processing system of claim 16, wherein said reference value is freely determinable, particularly freely programmable.

18. The micro controller and micro processor, stored-program controller (SPC) and data processing system of claim 16, wherein said response is freely determinable, particularly freely programmable.

19. The micro controller and micro processor, stored-program controller (SPC) and data processing system of claim 16, wherein said reference value and said response can be deposited with n bits, with n being any natural number (positive integer) and with n being preferably determined by the register capacity of said input register (17, 41) and output register (25, 49).

20. The control unit of claims 4, wherein said statement has a width of m bits, with m being any natural number.

21. The micro controller and micro processor, stored-program controller (SPC) and data processing system of claim 16, wherein one or more input lines (11, 12, 13, 14, 15, 16) are assigned to said input registers (17, 41).

22. The micro controller and micro processor, stored-program controller (SPC) and data processing system of claim 16, wherein one or more output lines (32, 33, 34, 35, 36, 37, 38) are assigned to said output registers (25, 49).

23. The micro controller and micro processor, stored-program controller (SPC) and data processing system of claim 16, wherein one or more input lines (11, 12, 13, 14, 15, 16) are assigned to said input registers (17, 41) and one or more output lines (32, 33, 34, 35, 36, 37, 38) are assigned to said output registers (25, 49).

24. The micro controller and micro processor, stored-program controller (SPC) and data processing system of claim 16, wherein a plurality of input registers (17, 41) is assigned to precisely one output register (25, 49).

25. The micro controller and micro processor, stored-program controller (SPC) and data processing system of claim 16, wherein precisely one input register (17, 41) is assigned to a plurality of output registers (25, 49).

26. The micro controller and micro processor, stored-program controller (SPC) and data processing system of claim 16, wherein precisely one output register (25, 49) is assigned to precisely one input register (17, 41).

27. The micro controller and micro processor, stored-program controller (SPC) and data processing system of claim 16, wherein at least one of said output registers (25, 49) is connected to at least one input register (17, 41) by means of a feedback line (39, 40).
